(19) United States
(12) Patent Application Publication
(10) Pub. No.: US 2016/0092808 A1
(43) Pub. Date: Mar. 31, 2016

(54) PREDICTIVE MAINTENANCE FOR CRITICAL COMPONENTS BASED ON CAUSALITY ANALYSIS

(71) Applicants: Yu CHENG, Shanghai (CN); Mengjiao WANG, Shanghai (CN); Gufei SUN, Shanghai (CN); Wen-Syan LI, Fremont, CA (US)

(72) Inventors: Yu CHENG, Shanghai (CN); Mengjiao WANG, Shanghai (CN); Gufei SUN, Shanghai (CN); Wen-Syan LI, Fremont, CA (US)

(21) Appl. No.: 14/496,961

(22) Filed: Sep. 25, 2014

(51) Int. Cl. G06Q 10/06

(52) U.S. Cl. CPC G06Q 10/0635; G06Q 10/0639

(57) ABSTRACT

A maintenance data collector may be used to collect maintenance data characterizing maintenance events associated with maintaining operations of a plurality of components, and a critical component identifier may be used to identify, from the plurality of components and based on the maintenance data, critical components that contribute disproportionately to production losses caused by the maintenance events. A causality analyzer may then determine causal connections between the maintenance events, based on operational dependencies between pairs of the plurality of components, and a maintenance policy generator may generate a maintenance policy governing future maintenance events for the plurality of components, based on the identified critical components and the causal connections.

### TECHNICAL FIELD

This description relates to component maintenance in production facilities.

### BACKGROUND

Production activities for physical goods that are manufactured or otherwise produced for sale are typically subject to constraints regarding, for example, timeliness, efficiency, reliability, safety, or volume. For example, a manufacturing facility may be required to produce a certain type of item for sale within a certain time limit of orders being received, while meeting a monthly production quota and minimizing an amount of downtime experienced by the production system. If such goals are met, then related goals of profitability and customer satisfaction are also more likely to be met.

In order to meet these and other goals, it is helpful to maximize efficient use of available production equipment, while minimizing associated costs and downtime. For example, production equipment is typically subject, over time, to malfunction, breakage, and/or degraded performance due to general wear and tear. Consequently, repair, replacement, and/or other maintenance are required for continued fulfillment of production goals.

However, it is often difficult to determine how to implement such maintenance activities. For example, a production facility may include many different types of production equipment, which may degrade at different rates or be subject to varying levels of likelihood of breakage. If too little maintenance is undertaken, then equipment is more likely to malfunction over time, thereby leading, for example, to increases in total equipment downtime and repair costs, or, in some cases, to increases in accidents that may result in human safety and/or environmental concerns. On the other hand, if too much maintenance is undertaken, excess costs associated with any unnecessary maintenance are wasted.

### SUMMARY

Accordingly, techniques may be implemented that allow accurate prediction of a need for maintenance activities with respect to associated production equipment. Moreover, such predictions may be made with respect to equipment components that are determined to be critical for maintenance purposes. For example, analysis may determine components which precede dependent components within production operations. Consequently, such critical components, were they to malfunction, would cause a chain reaction of malfunctions or unavailability of the related, dependent components. Similarly, critical components may be defined with respect to safety or environmental concerns that would be present in the event of failure thereof. By predicting maintenance requirements for such critical components, maintenance costs and associated downtime may be reduced, while profitability, along with employee and customer satisfaction, may be increased.

According to one general aspect, a system includes at least one processor, and instructions recorded on a non-transitory computer-readable medium, and executable by the at least one processor. The system includes a maintenance data collector configured to collect maintenance data characterizing maintenance events associated with maintaining operations of a plurality of components, and a critical component identifier configured to identify, from the plurality of components and based on the maintenance data, critical components that contribute disproportionately to production losses caused by the maintenance events. The system also includes a causality analyzer configured to determine causal connections between the maintenance events, based on operational dependencies between pairs of the plurality of components, and a maintenance policy generator configured to generate a maintenance policy governing future maintenance events for the plurality of components, based on the identified critical components and the causal connections.

According to another general aspect, a computer-implemented method for executing instructions stored on a non-transitory computer readable storage medium may include collecting maintenance data characterizing maintenance events associated with maintaining operations of a plurality of components, and generating a criticality score for each of the plurality of components, based on a comparison of each criticality score to a threshold, wherein each criticality score is calculated as an aggregation of factors related to production losses caused by the maintenance events. The method may include identifying, from the criticality scores, critical components that contribute to the production losses, determining causal connections between the maintenance events, based on operational dependencies between pairs of the plurality of components, and generating a maintenance policy governing future maintenance events for the plurality of components, based on the identified critical components and the causal connections.

According to another general aspect, a computer program product may be tangibly embodied on a non-transitory computer-readable storage medium and may include instructions. The instructions, when executed, are configured to cause at least one processor to collect maintenance data characterizing maintenance events associated with maintaining operations of a plurality of components, and identify, from the plurality of components and based on the maintenance data, critical components that contribute disproportionately to production losses caused by the maintenance events. The instructions, when executed, are further configured to cause the at least one processor to determine causal connections between the maintenance events, based on operational dependencies between pairs of the plurality of components, and generate a maintenance policy governing future maintenance events for the plurality of components, based on the identified critical components and the causal connections.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for predictive maintenance for critical components based on causality analysis.

FIG. 2 is a block diagram of a more detailed example of the system of FIG. 1.

FIG. 3A is a table illustrating a format of collected event data for the systems of FIGS. 1 and 2.

FIG. 3B is a table illustrating a format of collected condition data for the systems of FIGS. 1 and 2.

FIG. 4 is a flowchart illustrating example operations of the systems of FIGS. 1 and 2.

FIG. 5 is a flowchart illustrating a more detailed example of the flowchart of FIG. 4.

FIG. 6 is a flowchart illustrating example operations for identifying critical components in a production facility.

FIG. 7 is a flowchart illustrating example operations for providing a maintenance policy for a production facility.

FIG. 8 is a graph illustrating a network structure in an example production facility.

FIG. 9 is a graph illustrating probability tables associated with the network structure of FIG. 8.

FIG. 10 is a network graph illustrating maintenance input for the network structure of FIG. 8.

### DETAILED DESCRIPTION

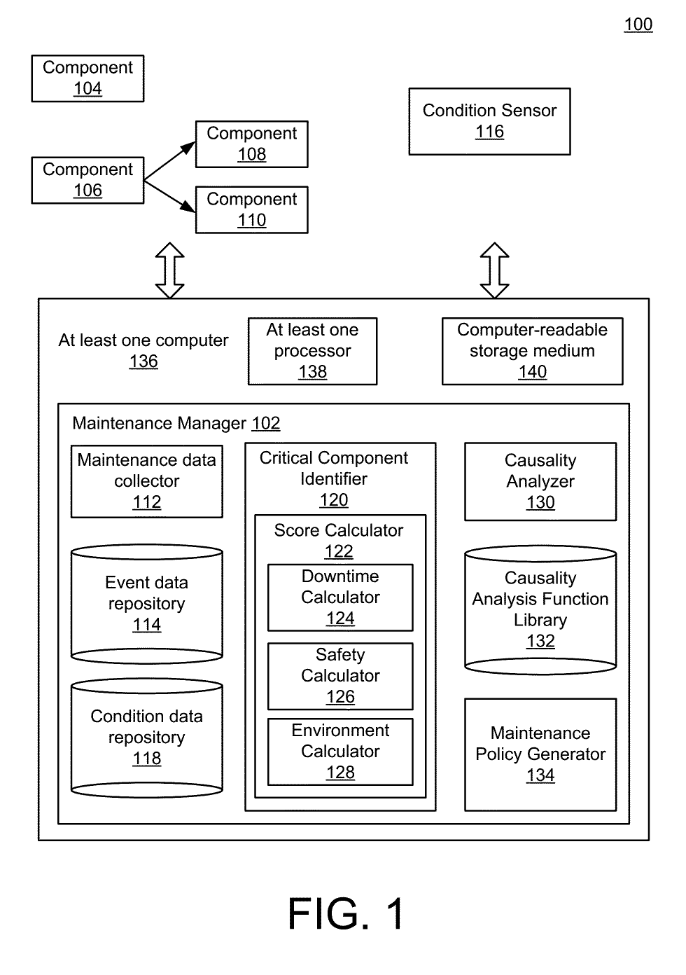

FIG. 1 is a block diagram of a system 100 for predictive maintenance for critical components based on causality analysis. In the example of FIG. 1, a maintenance manager 102 may be configured to monitor components 104-110 of a production facility, and to generate a maintenance policy that satisfies goals of an administrator of the production facility.

More particularly, the maintenance manager 102 may include a maintenance data collector 112 that is configured to collect various types of maintenance data. In the example of FIG. 1, the maintenance data collector 112 is illustrated as collecting maintenance event data within an event data repository 114, along with condition data captured from one or more condition sensors 116 and stored within a condition data repository 118.

For example, the components 104-110 should be understood generally to represent virtually any physical components that may be involved in operations of a production facility. For example, such production facilities may include manufacturing facilities designed to construct physical goods for sale. In other examples, the components 104-110 may be related to physical sorting or other movement of physical goods that have already been constructed, such as may occur in a warehouse, inventory management, or shipping facility, or in an oil or gas production facility.

Thus, the types of physical components represented by the components 104-110 are far too numerous to list here in detail, but would be apparent to one of skill in the art. By way of non-limiting example, however, it may be appreciated that the components 104-110 may represent, e.g., conveyer belts, assembly equipment, transportation equipment, robotic assistance, computers, safety equipment, tools, and virtually any other type of physical component that may be used in the types of production facilities referenced above, or in other production facilities.

By their nature, all such physical components are prone to eventual performance degradation or failure. Without preventive maintenance, such performance degradations or failures may lead to safety concerns, such as when equipment failure injures an employee of the production facility. Similarly, such performance degradations or failures may lead to environmental hazards, such as when equipment designed to handle hazardous waste malfunctions. Further, such performance degradations and failures may result in production delays within the production facility, resulting in lost profits and decreased customer satisfaction.

Moreover, even when preventative maintenance is undertaken, it may be necessary to take one or more components offline in order to perform a repair or other maintenance activity. The resulting downtime for such components may thus also lead to production delays and other production losses. Moreover, costs are incurred by such maintenance activities, including costs for employees or other persons responsible for executing the maintenance activities, costs for temporary or permanent replacement parts, costs associated with taking components offline and then putting the maintained components back online, and various other associated costs. Therefore, although preventative maintenance may reduce a likelihood of safety and environmental concerns, and may reduce a likelihood of abrupt component failures in critical situations and/or situations in which repair would be difficult or impossible, excessive or unnecessary preventative maintenance may nonetheless result in unnecessary delays, reductions in profitability or customer satisfaction, or other production losses, as compared to scenarios in which optimal maintenance policies are enacted.

Therefore, in the example of FIG. 1, maintenance data should be understood to represent virtually any data that may be related to the determination of such optimal maintenance policies. Such maintenance data may thus include any information related to the components 104-110, and operations thereof, including all available descriptive data characterizing time periods before, during, and after preventative or reparative maintenance activities that occur.

In the example terminology of FIG. 1, maintenance event data stored within the event data repository 114 may include data collected by the maintenance data collector 112 in conjunction with a specific maintenance event. Such event data may be generated and collected automatically, and/or may be received by way of manual input, e.g., from an administrator of the production facility, or from repair personnel, or any appropriate employee of the production facility.

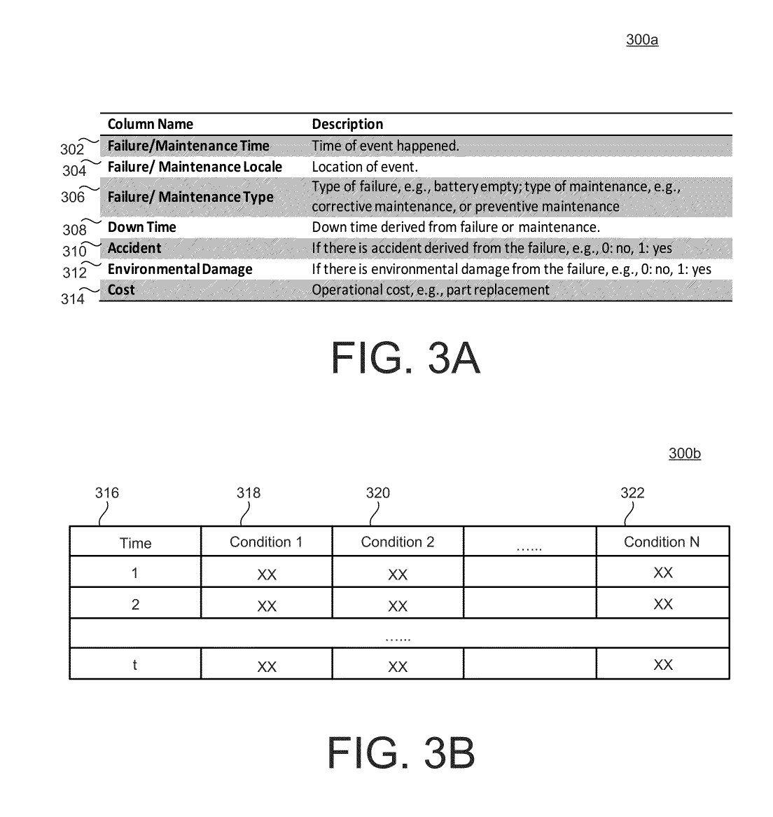

For example, in some implementations, various ones of the components 104-110 may include, or be associated with, software that is designed to automatically generate report data in the event of a failure or other malfunction. Similarly, repair equipment used to repair a particular component may be configured to transmit repair activities undertaken. In other examples, repair personnel may be provided with appropriate hardware/software (e.g., by way of a graphical user interface of a repair device or computer associated therewith), so as to thereby provide the maintenance event data in a convenient, consistent manner. Additional details regarding example event data and event data formatting, including an example data schema for the event data repository 114, are provided below, e.g., with respect to FIG. 3A.

As referenced above, maintenance data collected by the maintenance data collector 112 may also include condition data collected by one or more condition sensors 116 and stored within the condition data repository 118. In this regard, such condition data may be understood to include virtually any data collected by an appropriate, corresponding type of sensor, which characterizes relevant conditions within the production facility, or associated with the production facility, that may potentially affect operations of the components 104-110.

For example, such condition data may be collected from the condition sensor 116 without being limited to a condition of a particular one of the components 104-110, or with respect to a particular maintenance event or activity associated with a particular one of the components 104-110. Instead, in example implementations, the condition sensor 116 may be positioned to collect condition data representing prevailing conditions within a vicinity of, or local to, one or more of the components 104-110.

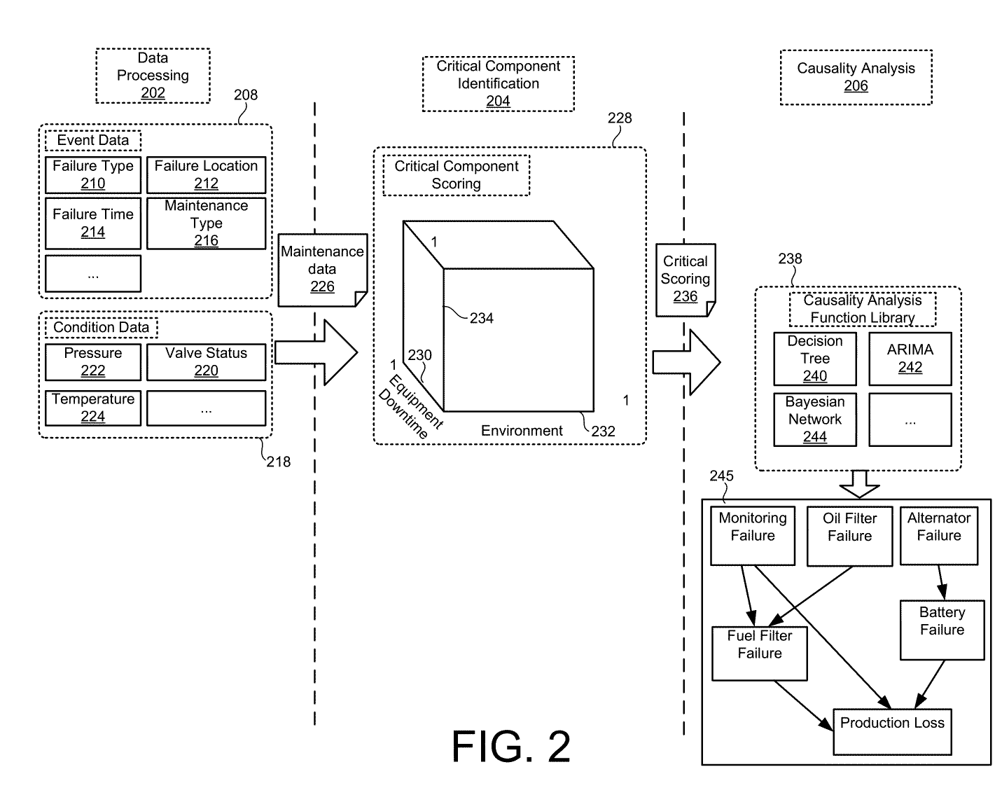

By way of non-limiting example, such condition data may thus include temperature or pressure readings, weight or volume measurements, characterizations of ambient light, noise, or vibration, a presence or absence of a particular chemical or other substance, or virtually any other measurable or quantifiable condition that may exist within or around the production facility in question. Further, in some cases, the condition data may relate directly to specific ones of the components 104-110, or operations thereof. For example, many or all of the types of condition data just referenced may be collected with respect to operations of a particular component. Additionally, characterizations of such component operations also may be collected, such as a speed of component operation, a number of component operation in a given time period, a reliability of component operations or virtually any other metric that may potentially be related to characterizing a current or future need for maintenance activity. Further examples of types of condition data are provided below, e.g., with respect to FIG. 2, while example formatting schemes for collecting condition data are illustrated and described below with respect to FIG. 3B.

Thus, maintenance data collected by the maintenance data collector 112 generally includes any and all available information related to past or potential maintenance activities with respect to all of the components 104-110. Moreover, as referenced above, by their nature, all of the components 104-110 are prone, to varying degrees, to eventual performance degradation or failure. However, it also may be true that, even though all of the components 104-110 are subject to eventual performance degradation or failure, some of the components 104-110 may be more critical than others with respect to development of an optimal maintenance policy.

Consequently, the maintenance manager 102 is illustrated as including a critical component identifier 120 that is configured to identify such critical components from among the components 104-110. In this regard, as explained in detail below, such a critical component should be understood to include a component, or type or category of component, that, when experiencing failure, repair, or other maintenance activity, contributes disproportionately to overall production losses associated with maintenance of the components 104-110 as a whole, and/or that has a causal effect on downtime of other, related components.

In this regard, as also described in detail below, production losses should be understood in a broad and general sense. For example, such production losses would obviously include literal reductions in revenue and profitability that result directly from money spent on repair or other maintenance activities, and/or sales lost due to lack of timely availability of products for sale. Production losses should also be understood to include any indirect or even intangible losses that may occur, such as insurance or health costs associated with accidents or injuries experienced by employees, or customer dissatisfaction or general loss of reputation associated with environmentally harmful accidents that occur as a result of a failed maintenance policy. Production losses should also be understood to include reductions in items being produced for sale, including, e.g., a reduced number of individual items being produced (such as toys, clothes, cars, or any consumer good), or a reduced volume of a material being transported or produced (such as oil or gas). Thus, production losses as used herein should be understood to include all such actual costs and opportunity costs associated with failures of maintenance policy, as well as the types of less tangible factors just referenced, to the extent that they may be quantified for use in calculations performed by the maintenance manager 102, as described herein.

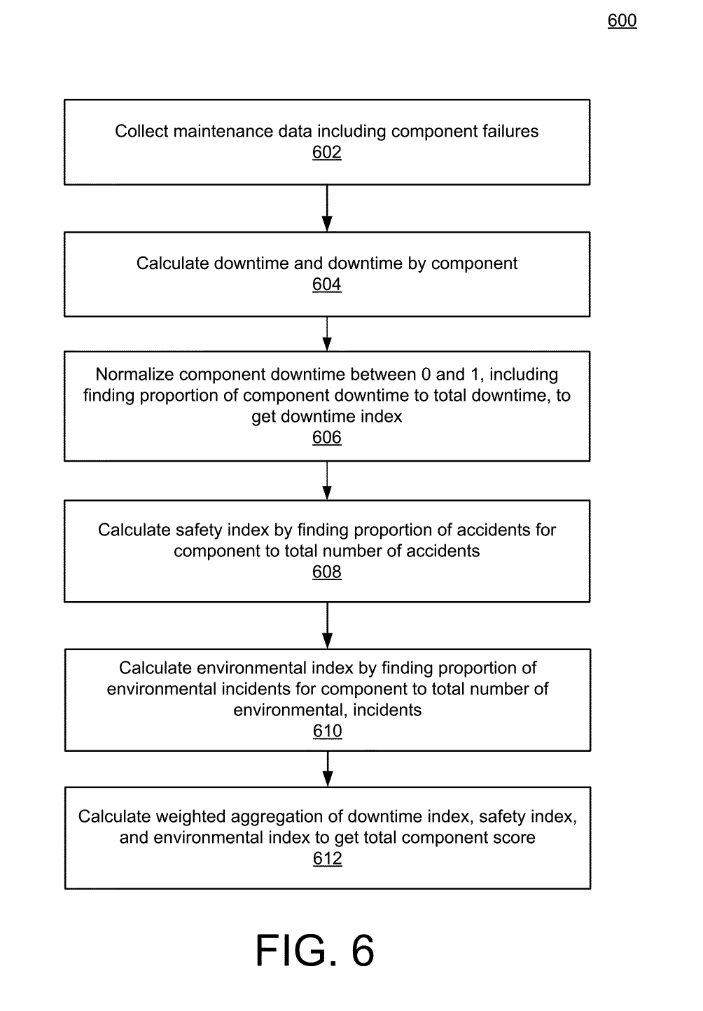

Additional example operations of the critical component identifier 120 are provided below, e.g., with respect to FIGS. 2-6. However, for purposes of the example of FIG. 1, the critical component identifier 120 is illustrated as including a score calculator 122. The score calculator 122 may be configured to calculate a criticality score for each of the components 104-110. In the example of FIG. 1, and as described in more detail below with respect to FIG. 6, the score calculator 122 may be configured to calculate an aggregated criticality score for each component, where the aggregated criticality score represents a weighted combination of several score factors.

Specifically, as shown, a downtime calculator 124 may be configured to calculate a downtime index characterizing a length of time during which a particular component or type of component is non-operational due to a component failure, or other maintenance activity which requires the component to be taken offline. As referenced above, a degree of criticality of a particular component may be characterized with respect to a relative or proportional contribution of that component (or failure thereof) to overall downtime or other metric related to production losses. In a simplified example, it may occur that, within a given time period, e.g., a month, the components 104-110 may experience a total, accumulated downtime among them of 4 days. If, however, the component 106 experiences a downtime of 3 of those 4 days, then the component 106 may be judged to contribute a high downtime index score (here, 75%) for inclusion within the overall, aggregated criticality score.

Somewhat similarly, a safety calculator 126 may be configured to compute a safety component of the overall criticality score. For example, the safety calculator 126 may access the event data repository 114 and/or the condition data repository 118, in order to determine a number or type of accident that may have occurred in conjunction with a failure of any one of the components 104-110, or some other safety metric. Again, a relative or proportional contribution of any one such component, or type of component, may be calculated.

Also within the score calculator 122, an environment calculator 128 may be configured to utilize available maintenance data to quantify or otherwise characterize environmental impact factors associated with failures of the components 104-110. As described above with respect to the calculators 124, 126, the environment calculator 128 may determine a relative or proportional occurrence or impact of environmental incidents associated with a particular component or type of component, as compared to overall types or quantities of environmental incidents experienced by the production facility as a whole, or by defined subsets thereof, within a given time period.

Upon completion of operation of the calculators 124-128, the score calculator 122 may proceed to compute a weighted, combined score for each included component. For example, as described in detail below, administrators of various production facilities may wish to give greater or lesser weight to the factors of downtime, safety, and/or environmental impact, and the score calculator 122 may be configurable in this regard.

Moreover, it will of course be appreciated that the various factors considered by the example score calculator 122 of FIG. 1 are merely non-limiting examples of the types of criticality score factors that may be utilized by the critical component identifier 120. For example, it may occur that a failed component experiences relatively little downtime in cases in which a temporary replacement component is available. However, cost associated with such replacement components, and/or with other activity required to avoid downtime and maintain operations of the production facility during a repair or replacement of the failed component, may also be quantified and included within the criticality score for the component in question.

Further in FIG. 1, a causality analyzer 130 may be configured to determine causal connections between maintenance events and other operational characteristics of the various components 104-110. In this regard, it may be appreciated that, although the simplified example of FIG. 1 illustrates only the 4 components 104, 106, 108, and 110, actual production facilities will often utilize hundreds or thousands of production components. Moreover, these production components often, by definition, work together to complete larger production tasks, and, therefore, often depend upon successful completions of previous component operations in order to achieve these larger tasks.

In the simplified example of FIG. 1, such dependencies are represented by the illustrated order of operations, in which operations of the component 106 occur before operations of the components 108, 110, which themselves are illustrated as occurring in parallel. Meanwhile, the component 104 is illustrated separately from the components 106-110, so that operations thereof should be understood to be independent of operations of the components 106-110 (at least for purposes of the portion of overall component operations of the production facility illustrated in the simplified example of FIG. 1).

As a result of such dependencies between pairs of components, it may be difficult to determine whether and how to execute maintenance activities. For example, it may occur that the component 108 has a high criticality score, and, for example, may experience significant downtime due to malfunction and associated repair activities. Meanwhile, the component 106 may experience less downtime, and may experience lower repair costs when such downtime occurs. Nevertheless, if failure of the component 106 is a direct cause of failure of the component 108, it would be unwise to construct a maintenance policy focusing on maintenance of the component 108, since production losses would be minimized in a more efficient and cost effective manner by prioritizing maintenance activities (including preventative maintenance) with respect to the component 106.

In some cases, it may be straightforward to determine and characterize causal connections existing in conjunction with operational dependencies between pairs of components. For example, it may occur that the component 108 is a delicate component, which includes a number of interacting parts, which may be difficult, expensive, and time consuming to replace or repair. Meanwhile, the component 106 may be a component that exerts force during operation, such as a conveyer belt or transportation arm. Then, during a malfunction of the component 106, physical damage to the component 108 may occur, thereby necessitating repair and associated downtime for the component 108, which, in the example, may be significantly more costly and time consuming than the associated repair for the component 106.

In many cases, however, causal connections between pairs of components may not be so obvious or easy to identify or quantify. For example, in some cases, even though operations of the component 106 may precede operations of the components 108, 110 within an overall workflow of the production facility, failure of the component 106 may not necessarily result in any failure or associated downtime of one or both of the components 108, 110. For example, the component 108 may include a conveyer belt that is used to convey various types of equipment, and may depend on operation of the component 106 in the sense that items output by the component 106 are conveyed using the conveyer belt. Nonetheless, the conveyer belt may also be used to convey various other items or types of items, and failure of the component 106 to produce items for inclusion and operations of the conveyer belt will neither cause failure of the conveyer belt, nor inability of the conveyer belt to convey items produced by other components.

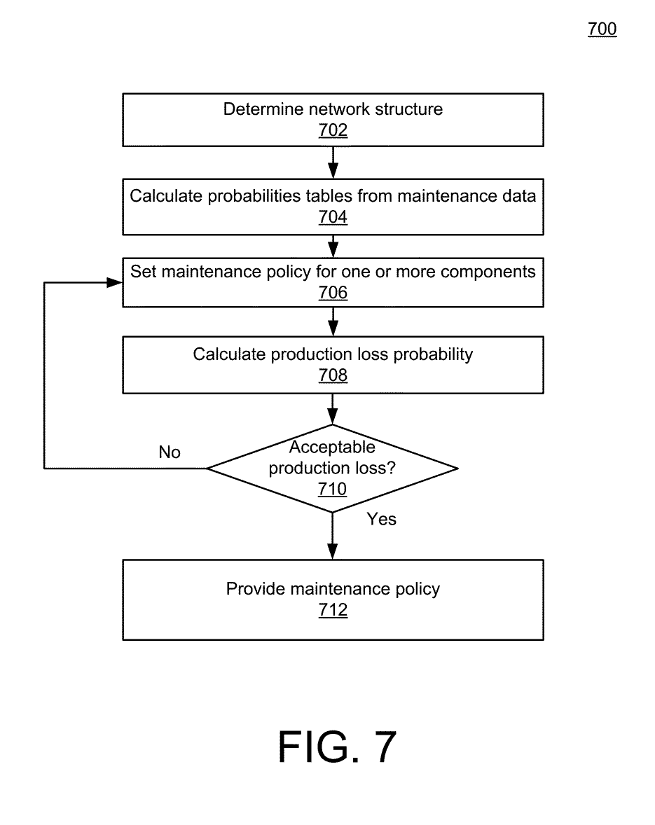

More generally, as described below with respect to FIGS. 7-10, the causality analyzer 130 is configured to calculate a probability of failure of the component 108, given a failure of the component 106. Even more generally, the causality analyzer 130 may quantify probability of failure of the component 108, in consideration of a number of preceding factors, including components which precede the component 106 (not shown in FIG. 1), or in the presence of various operational conditions (e.g., bad weather, or other conditions sensed by the condition sensor 116).

Thus, in practice, a causality analysis function library 132 may be constructed and utilized to quantify and characterize such causal connections, and to predict an efficacy of a potential maintenance policy. More specifically, and as described in detail below, the causality analysis function library 132 may be utilized to store available algorithms or other functions for characterizing a type or extent of causality that exists between two or more components.

In general, maintenance data from the repositories 114, 118 may be examined by the causality analyzer 130, and one or more functions from the causality analysis function library 132 may be utilized to analyze such historical maintenance data and thereby derive and characterize causal connections between components. For example, in the examples of FIGS. 7-10, a Bayesian network may be utilized to construct and characterize conditional probability tables as a means of describing causal connections between components. However, as referenced below with respect to FIG. 2, other functions may be used, such as, for example, various known machine learning algorithms, neural networks, or any other suitable function capable of analyzing historical maintenance data for purposes of enabling predictions of future causal connections between failures of dependent components.

Based on outputs of the critical component identifier 120 and the causality analyzer 130, a maintenance policy generator 134 may be configured to provide a maintenance policy governing a type, extent, and timing of future maintenance activities. For example, such a maintenance policy might specify that the component 106 undergo specified types of maintenance activities twice a month, while the component 108 is scheduled for different maintenance activities according to a different schedule, e.g., monthly.

In addition to specifying component level maintenance activities as part of such maintenance policies, the maintenance policy generator 134 is capable of quantifying and otherwise characterizing relative benefits of potential maintenance policies with respect to actual or potential production losses occurred. For example, the maintenance policy generator 134 may provide a number of different potential maintenance policies, along with associated information regarding corresponding production and production losses, so that a user of the system 100 may select an appropriate, desired maintenance policy. Similarly, the maintenance policy generator 134 may provide an appropriate graphical user interface for such a user to explore various “what-if” scenarios with respect to relative effects of potential changes to the existing maintenance policy, as quantified with respect to associated potential production losses.

Put another way, the maintenance policy generator 134 essentially has access to a large solution space of potential maintenance policies provided by the critical component identifier 120 and the causality analyzer 130, and predicated on maintenance data received from the maintenance data collector 112. This solution space for potential maintenance policies may be explored manually, as just referenced, or may be explored using available algorithms. For example, the maintenance policy generator 134 may utilize a greedy algorithm, a genetic algorithm, or some other suitable algorithm, to thereby explore the available solution space until some suitable threshold or other metric is reached.

In the example of FIG. 1, the maintenance manager 102 is illustrated as being executed using at least one computer 136. As shown, the at least one computer 136 includes at least one processor 138, as well as non-transitory computer readable storage medium 140. In operation, the at least one computer 136 may be implemented using any appropriate computing hardware/software platform, such as a desktop, laptop, notebook, netbook, or tablet computer. Consequently, the system 100 of FIG. 1 may be implemented in a convenient, widely applicable manner, for use by administrators of many different types of production facilities.

Thus, for example, the at least one computer 136 may represent two or more computers operating in communication with one another. The at least one processor 138 may represent two or more processors operating in parallel, and the non-transitory computer readable storage medium 140 may represent virtually any storage medium that is capable of storing instructions which, when executed by the at least one processor 138, causes the at least one processor 138 to execute the various functions described herein with respect to the maintenance manager 102.

Of course, FIG. 1 includes only a simplified example of the at least one computer 136, and it will be appreciated that many other conventional hardware and software components of the at least one computer 136 may be utilized in the system 100 of FIG. 1. For example, as referenced above, the at least one computer 136 may have access to appropriate network communication interfaces. In particular, the at least one computer 136 may be configured to interact with the condition sensor 116, using conventional sensor protocols, and may otherwise be configured to interact with any hardware or software necessary to obtain the maintenance data collected by the maintenance data collector 112 and stored within the repositories 114, 118.

Similarly, the maintenance manger 102 and the at least one computer 136 may be associated with an appropriate monitor or other display, to thereby enable a user of the system 100 to interact with the maintenance manager 102. For example, as referenced, the maintenance policy generator 134 may provide a suitable interface for allowing the user of the system 100 to explore and select from among available maintenance policies. More generally, one or more suitable user interfaces may be analyzed to allow the user of the system 100 to configure any of the maintenance data collector 112, the critical component identifier 120, the causality analyzer 130, or any other portion or sub-portion of the maintenance manager 102.

Further, although the maintenance manager 102 is illustrated as including a number of separate modules, it may be appreciated that the maintenance manager 102 of FIG. 1 is intended merely as a non-limiting example of implementations thereof. For example, in other implementations, additional or alternative modules may be included. Similarly, any individual module of the maintenance manager 102 may be implemented as two or more separate sub-modules, while, conversely, any two or more modules of the maintenance manager 102 may be combined for implementation as a single module.

FIG. 2 is a diagram illustrating more detailed example operations of the system 100 of FIG. 1. In the example of FIG. 2, 3 primary operational stages are illustrated, which correspond generally to operations of the maintenance data collector 112, the critical component identifier 120, and the causality analyzer 130. Specifically, as shown, a data processing stage 202 precedes a critical component identification stage 204, which itself serves as input to causality analysis 206.

In the example data processing operation 202, event data 208 and condition data 218 correspond generally to data stored in the event data repository 114 and the condition data repository 118, respectively. In the example of FIG. 2, the event data 208 is illustrated as including a number of examples of event data. Specifically, examples include data related to a type of a failure 210, a failure location 212, a failure time 214, a maintenance type 216, and any other appropriate or desired type of event data that may be specified by an administrator of the system 100.

By way of further example, FIG. 3A illustrates an example schema for the event data 208. As shown, a failure/maintenance time 302 refers to data records indicating a time of a maintenance event. A failure/maintenance location 304 refers to a location of the maintenance event, and a failure/maintenance type 306 refers to a type or category of a particular failure (e.g., an empty battery as an example of failure, and/or specific types of corrective or preventative maintenance as examples of types of maintenance).

Further in FIG. 3A, downtime 308 refers to a quantity of time during which a corresponding piece of equipment or other component is partially or completely non-operational, due to a failure and/or maintenance thereof. An accident field 310 indicates whether an accident was associated with a specific failure. In the example, the event data schema of FIG. 3A uses a binary representation for indicating accidents, or lack thereof. That is, a value of 1 indicates that an accident occurred, while a value of 0 indicates that no accident was associated. Of course, this is intended merely as a simplified, non-limiting example, in other implementations, various degrees or types of accidents may be included (e.g., indication may be associated with a type or extent of injury, and/or health insurance costs associated with particular types of accidents).

Also in FIG. 3A, an environmental damage field 312 is used to indicate whether or not environmental damage was associated with a failure. As with the accident field 310, the environmental damage field 312 may be represented in binary fashion, as shown in the simplified example of FIG. 3A. However, in other implementations, as with the accident field 310, various types and degrees of indications of environmental damage may be included. For example, indications of whether government fines were assessed, or whether additional costs specifically associated with the environmental damage (e.g., environmental cleanup costs) could also be included.

Finally in the example of FIG. 3A, a cost field 314 refers to an operational cost associated with the failure or other maintenance. For example, such costs can be associated with a cost of a replacement part, including associated delivery fees and delivery times. As referenced herein, such operational costs can also refer to costs associated with temporary replacement parts that are used until new replacement parts are received, or any other costs related to, or caused by, a particular failure.

Referring back to FIG. 2, condition data 218 is illustrated as including various types of measured or sensed data that may be obtained from the one or more condition sensors 116. As shown, the condition data 218 may include, for example, pressure measurements 222, valve status measurements 220, and temperature measurements 224.

With reference to FIG. 3B, a more detailed example of techniques for capturing and storing condition data is illustrated therein. Specifically, as shown, condition data may be sampled over a period of time, at sampling intervals identified within a time column 316 of a condition data table 300B of FIG. 3B. Further in FIG. 3B, individual condition measurements for specified conditions (e.g., the conditions 220, 222, 224 of FIG. 2) are illustrated in FIG. 3B generically as columns 318, 320, 322 for example conditions of condition 1, condition 2, and condition N, respectively. In other words, such condition data may be captured and stored as a time series of data, sampled at a defined time interval, and stored in the type of table 300B illustrated in FIG. 3B.

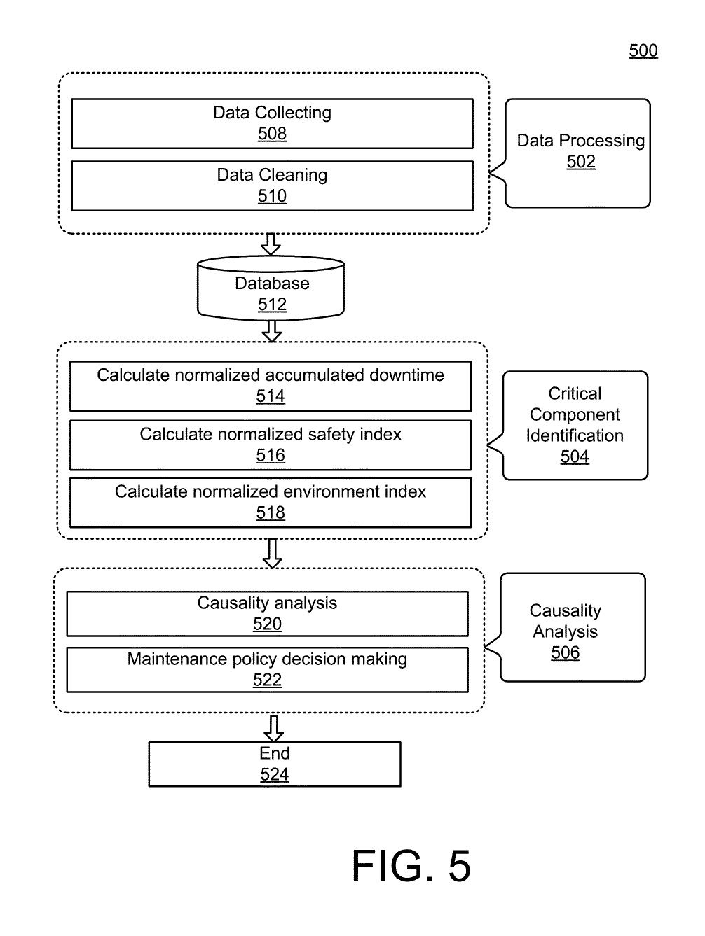

Thus, as described above with respect to FIG. 1, maintenance data 226 may be provided by the maintenance data collector 112 from the repositories 114, 118 to the critical component identifier 120, corresponding to the critical component identification stage 204 of FIG. 2. As referenced above, and described in more detail below, e.g., with respect to FIG. 5, the maintenance data collector 112 may perform additional processing on collected maintenance data, before providing resulting, processed maintenance data 226.

For example, as may be appreciated from the above descriptions of FIGS. 3A and 3B, the maintenance data collector 112 may be configured to format the event data 208 and the condition data 218 according to any applicable schema or format. Moreover, the maintenance data collector 112 may perform a data cleaning operation, e.g., to remove data that has a high probability of being spurious or otherwise incorrect, or that is determined not to be useful for any reason with respect to further operations 204, 206 of FIG. 2. Still further, the maintenance data collector 112 may utilize the condition data 218 to improve the event data 208. For example, it may occur that measurements are missing or otherwise unavailable within the event data 208, and the maintenance data collector 112 may utilize the condition data 218 to determine relevant condition data that was collected at a time corresponding to a time of missing data from within the event data 208.

Then, it may be possible for the maintenance data collector 112 to infer, deduce, or otherwise obtain at least an approximate replacement value for any such missing data values within the event data 208. As a simplified example, it may occur that the event data 208 includes, for a specific failure, a known failure type 220 associated with a first valve. However, the corresponding failure location 212 may not be known from reported event data. Then, the maintenance data collector 112 may review the condition data 218 to determine a time of high pressure 222 and/or failed valve status 220, and may use a location of the one or more condition sensors 116 that detected such pressure/status condition data, in order to fill in a corresponding failure location 212 within the event data 208.

Then, during the critical component identification stage 204, the maintenance data 226 may be utilized during a critical component scoring operation 228. As described above with respect to the score calculator 122, and included calculators 124, 126, 128, such critical component scoring 228 may include 3 axes, illustrated in FIG. 2 an equipment downtime access 230, and environment access 232, and a safety access 234. Then, as referenced above and described in detail below with respect to FIG. 6, three individual scores, corresponding to the three axes 230-234 may be calculated and may each be normalized to a value between 0 and 1. Accordingly, a composite critical component score may be calculated as having a value within the cube volume defined by the three axes 230-236. Of course, as also referenced above, FIG. 2 provides merely a single, simplified example of critical component scoring. In practice, various other factors may be considered, and/or may be combined in any suitable fashion.

As a result of the critical component identification stage 204, criticality scoring 236 may be provided from the critical component identifier 120 for use in the causality analysis stage 206 performed by the causality analyzer 130 of FIG. 1. Specifically, as described above, the causality analysis function library 132 may be constructed as a data mining library utilizing state of the art algorithms to analyze causalities among critical components, to thereby enable the maintenance policy generator 134 to generate one or more potential maintenance policies.

In the example of FIG. 2, the causality analysis function library 238 is illustrated as including a number of potential algorithms that may be used to implement the causality analyzer 130. Particularly, as shown, the library 238 may include a decision tree algorithm 240. As may be appreciated from the above description of FIG. 1, the decision tree algorithm 240 may be implemented to utilize the maintenance data 226 and the criticality scoring 236 to construct training information and associated attribute values, which may then be utilized to determine, in a predictive fashion, desired future values for maintenance policies. In other words, the decision tree algorithm 240 may be utilized to construct a classifier capable of inputting future maintenance scenarios, and predicting potential maintenance outcomes associated therewith, so that the maintenance policy generator 134 may select from among these to obtain one or more potentially optimal maintenance policies.

The ARIMA algorithm 242 is another example of a data mining algorithm that may be included within the library 238. The ARIMA algorithm 242 refers to the use of an Auto Regressive Integrated Moving Average model, which is particularly suited for time series analysis of data. That is, by sitting an ARIMA model to time series data, future points in the series may be predicted.

Further details regarding example implementations of the decision tree algorithm 240 or the ARIMA algorithm 242 are not provided herein, for the sake of conciseness. Instead, a Bayesian network 244 is utilized, e.g., with respect to FIGS. 7-10, to provide a specific, non-limiting example of a use of an algorithm of the causality analysis function library 238. Of course, many other types of algorithms may be used, alone or in combination, including, for example, support vector machines, neuro networks, various types of regression and/or clustering analysis, and any other appropriate type of machine-learning technique.

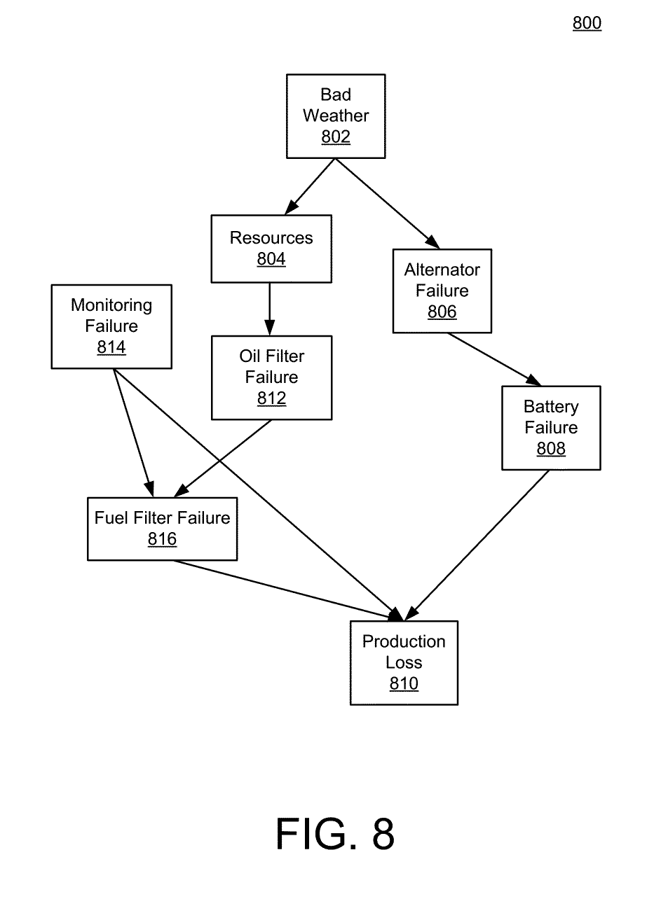

In the example of FIG. 2, and corresponding to the examples of FIGS. 8-10, a network structure 245 may be implemented and utilized in conjunction with the Bayesian network algorithm 244. Specifically, as described in detail below, a network structure reflecting dependencies between critical components, as determined in the context of the operational stages 202, 204, 206, may be represented graphically. Then, conditional probabilities characterizing a type or extent of likelihood of a particular component failure may be characterized by itself, and in conjunction with probabilities of failures of preceding components within the causal chain determined by the causality analyzer 130.

In this way, a likelihood of a particular type and extent of total production losses associated with a specific maintenance policy under consideration may be estimated. Then, such resulting potential maintenance policies may be explored or considered by the maintenance policy generator 134, using manual or automated techniques, as described herein.

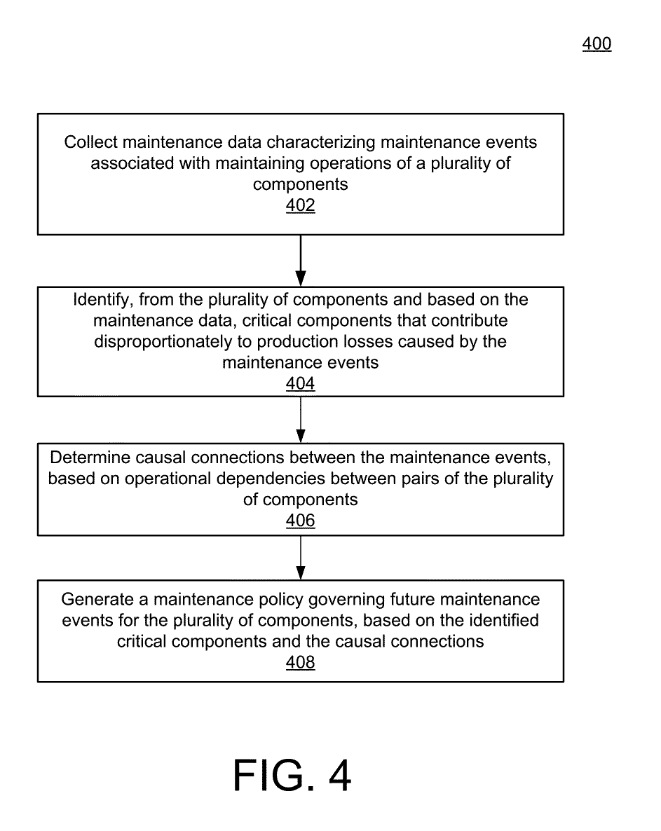

FIG. 4 is a flowchart 400 illustrating example operations of the system 100 of FIG. 1. In the example of FIG. 4, operations 402-408 are illustrated as separate, sequential operations. However, it may be appreciated that, in various implementations, additional or alternative operations may be included, while one or more operations may be omitted. In all such implementations, it may be further appreciated that any two or more such operations may be executed in a partially or completely overlapping or parallel manner, or in a nested, iterative, looped, or branched fashion.

In the example of FIG. 4, maintenance data characterizing maintenance events associated with maintain operations of a plurality of components may be collected (402). For example, the maintenance data collector 112 may populate the event data repository 114 with event data corresponding to the example event data schema 300A of FIG. 3A, specific examples of which are provided with respect to event data 208 of FIG. 2. As also described, such maintenance data may optionally include condition data from the condition data repository 118, as represented by way of example in the condition data 218 of FIG. 2, and collected in accordance with the example table 300B of FIG. 3B.

From the plurality of components and based on the maintenance data, critical components that contribute disproportionately to production losses caused by the maintenance events may be identified (404). For example, the critical component identifier 120 may be configured to identify such critical components by implementing the type of scoring calculations described with respect to the score calculator 122. In this way, for example, it may be determined that, within a time period in which the components 104 and 106 experienced the only failures experienced by the components 104-110 of a given production facility, the component 106 was associated with a large majority of associated production losses, while the component 104 caused a relatively smaller contribution to such production losses. In this way, as described herein, subsequent maintenance policy analysis may precede with a greater focus on, in the example, the component 106.

Causal connections between the maintenance events may be determined, based on operational dependencies between pairs of a plurality of components (406). For example, the causality analyzer 130 may determine that the components 108, 110 exhibit operational dependencies on preceding component 106, and may investigate and characterize a type and extent of a causal connection between a maintenance event experienced by the component 106 and one or more maintenance events experienced by one or both of the components 108, 110.

For example, as described herein, in some scenarios, a failure of the component 106 will directly cause a corresponding failure of one or both of the components 108, 110. In many other scenarios, however, there may be a correlation between such failures or other maintenance events, which may or may not rise to a level of actual or direct causality. For example, in the examples provided below in which a Bayesian network is utilized, conditional probabilities associating a failure of a particular component with one or more preceding conditions, including failure of a preceding component, may be characterized. Thus, it may be appreciated that the term causal connection or causality should be understood to include potential or inferred causation, thereby including correlations and probabilities of relationships between failures or other maintenance events.

A maintenance policy governing future maintenance events for the plurality of components may be generated, based on the identified critical components and the causal connections (408). For example, the maintenance policy generator 134 may be utilized to explore, manually or in an automated fashion, a solution space of potential maintenance events and associated scheduling thereof, so as to thereby obtain one or more maintenance policies that will be acceptable to an administrator or other user of the system 100 of FIG. 1.

FIG. 5 is a flowchart 500 illustrating more detailed example operations of the flowchart 400 of FIG. 4. In the example of FIG. 5, the three separate stages 502, 504, 506 correspond respectively to stages 202, 204, 206 of FIG. 2.

Specifically, for example, a data processing stage 502 is illustrated as including data collecting (508) followed by data cleaning (510), to thereby populate a database 512 of maintenance data. As may be appreciated from the above descriptions of FIGS. 1-4, such data collection may include collection by the maintenance data collector 112 of both maintenance event data and maintenance condition data. The subsequent data cleaning 510 may occur, e.g., periodically or at request of an administrator, or in response to collection of a certain quantity or type of maintenance data, to thereby optimize the maintenance data for inclusion within the database 512. For example, as described, the maintenance event data may be examined to remove unhelpful or incorrect event data, and condition data may be utilized to supplement or verify data within the collected event data.

Within the critical component identification stage 504, normalized, accumulated downtime may be calculated (514). For example, the downtime calculator 124 of the score calculator 122 may calculate a normalized score for equipment downtime of various types of equipment or other components, which may be characterized in proportion to a total downtime of components within a given production facility and within a given period of time.

Similarly, a normalized safety index value may be calculated (516), along with a normalized environment index value (518). As described above, although not specifically illustrated in the example of FIG. 5, the critical component identification 504 may include a weighted aggregation of the values calculated during operations 514-518, to thereby obtain total critical component scores for individual components or type of component.

Then, during the causality analysis stage 506, causality analysis may be executed (520), e.g., by the causality analyzer 130 of FIG. 1. As described, such causality analysis may include the use of one or more appropriate data mining algorithms to characterize causal connections between failures or other maintenance events experienced by pairs of operational dependent ones of the critical components identified during the critical component identification 504. Then, the results of parameterizing or otherwise training one or more selected data mining algorithms may be utilized to explore a solution space of possible maintenance policies, to thereby facilitate maintenance policy decision making (522), thereby ending the process 500 (524).

In the example implementation of FIG. 5, the maintenance policy decision making operation 522 is illustrated as being included within the causality analysis 506. However, in alternative implementations, such as described above with respect to FIG. 1, operations related to generation of maintenance policies may be considered separate from, but dependent upon, preceding causality analysis. In any case, it may be appreciated that the ability of the system 100, and the various operations of the flowchart 500 of FIG. 5, enable users to consider all available maintenance data, identify critical components, and determine and utilize causal connections between maintenance events when formulating potential maintenance policies.

FIG. 6 is a flowchart 600 illustrating more detailed example operations with respect to the critical component identification 504 and included operations 514-518, as well as operations of the critical component identifier 120 of FIG. 1 and the critical component identification stage 204 of FIG. 2.

In the example of FIG. 6, as already described, maintenance data is collected, including component failures (602). That is, as described, the maintenance data collector 112 may collect the maintenance event data within the event data repository 114, as well as the condition data within the condition data repository 118, and may perform the various collection and cleaning operations (508, 510) of the data processing stage 502 of FIG. 5, as also described in detail with respect to FIGS. 2, 3, and 3B.

Once collected, the critical component identifier 120 may proceed to calculate total downtime for all components 104-110 within a specified period of time, as well as a downtime experienced by each component or type of component within the production facility (or portions thereof) in question (604). For example, assuming that the event data repository 114 maintains maintenance event data in accordance with the event data schema of FIG. 3A, the historical event data may include a table of component failures, referred to herein as “Fail_Tab.” Then, such a failure table may include a column “downtime,” which records equipment downtime associated with an event in question. Then, downtime for all the events within the time period in question may be calculated, and information of the calculated downtime may be selected. An example technique for generating accumulated downtime of all the components 104-110 is represented by Pseudo code 1:

Pseudo code 1

| | |
|---|---|
| 1 | -- DOWNTIME is a column of the table of FAIL_TAB and denotes |
| | downtime of the event |
| 2 | -- Calculate downtime of all the events |
| 3 | SELECT SUM(DOWNTIME) AS ALL_DOWNTIME FROM |
| | FAIL_TAB; |

Then, component downtime may be normalized between values of 0 and 1, including finding a proportion of component downtime to total downtime, to thereby obtain a downtime index (606). In other words, as referenced above, within a total downtime calculated for components 104-110, a proportion of downtime experience by, for example, the component 104, relative to the total downtime, may be computed. Of course, similar calculations of proportional downtime may be executed for remaining ones of the components 106-110, or, may specifically, for any such component which experienced downtime within the relative timeframe. In this regard, it may be appreciated that each of the components 104-110 should be understood to represent, for example, a single component, or in other implementations, may represent a number of components which share a certain type or characteristic.

Then, continuing the example described above with respect to pseudo code 1, the normalized component downtime may be determined by first selecting a particular component or type of component, and then taking a ratio of a summation of all downtime for the component or type of component in question, relative to total downtime calculated using pseudo code 1, above. In this way, downtime by component may be calculated for each component or group of components, and normalized as a proportion to thereby obtain a normalized value between 0 and 1. Example pseudo code for performing such normalized component downtime calculations is provided below with respect to Pseudo code 2:

Pseudo code 2

| | |
|---|---|
| 1 | -- Calculate proportion of downtime of each component failure |
| 2 | SELECT COMPONENT, SUM(DOWNTIME)/ |
| | ALL_DOWNTIME AS ACCU_DOWNTIME FROM FAIL_TAB; |
| 3 | GROUP BY COMPONENT; |

Similarly, a safety index may be calculated by finding a proportion of accidents for a given component or type of component, relative to a total number of accidents (608). Further, an environmental index may be calculated by finding a proportion of environmental incidents for a component or type of component, relative to a total number of environmental incidents (610).

More specifically, in continuing the example above as provided with respect to Pseudo code 1 and Pseudo code 2, the failure table Fail_Tab may be accessed to count a number of total accidents, as well as individual accidents in conjunction with corresponding components. Then, for each component or type of component, the count of accidents therefore may be compared to the total number of accidents, and the various components or types of components may be grouped to obtain a relative proportion for each. Similarly, a count for environmental incidents may be obtained from the failure table Fail_Tab, and individual components or groups of components may be identified, so as to again obtain a proportional contribution of each to the total count of environmental incidents. Example pseudo code associated with operations 608, 610 is provided below as Pseudo code 3:

Pseudo code 3

| | |
|---|---|
| 1 | SELECT COUNT(ACCIDENT) AS ALL_ACCIDENT FROM |
| | FAIL_TAB; |
| 2 | SELECT COMPONENT, COUNT(ACCIDENT)/ |
| | ALL_ACCIDENT AS SAFETY_IND FROM FAIL_TAB |
| 3 | GROUP BY COMPONENT; |
| 4 | SELECT COUNT(ENVIRONMENT) AS |
| | ALL_ENVIRONMENT FROM FAIL_TAB; |
| 5 | SELECT COMPONENT, COUNT(ENVIRONMENT)/ |
| | ALL_ENVIRONMENT AS ENVIRONMENT_IND FROM |
| | FAIL_TAB |
| 6 | GROUP BY COMPONENT; |

Finally in FIG. 6, a weighted aggregation of normalized values for the downtime index, the safety index, and the environmental index may be calculated, to thereby obtain a total component score for each component or type of component (612). For example, for a particular component “A,” which, again, may represent a single component or a group or category of components, may be represented by equation 1.

Score(A)=alpha*ACCU_downtime(A)+beta*safety_index+gamma*environment_index Equation 1

In equation 1, alpha, beta and gamma represent weight values, e.g., specified between 0 and 1, so that specific values for alpha, beta, and gamma may be set by users of the system 100, based on their preference or specific domain knowledge. A threshold may be selected, so that components having scores higher than threshold are determined to be critical components.

FIG. 7 is a flowchart 700 illustrating more detailed example operations with respect to the causality analyzer 130 and the maintenance policy generator 134 of FIG. 1, as also described with respect to causality analysis 206 of FIG. 2 and causality analysis 506 of FIG. 5. In the example of FIG. 7, examples are provided in the context of using the Bayesian network algorithm 244 of the causality analysis function library 238 of FIG. 2. As referenced above, such a Bayesian network algorithm is constructed through the use of conditional probabilities. That is, such conditional probabilities indicate a probability of a second condition, dependent upon occurrence of a preceding, first condition (or group of preceding conditions). For example, notationally, such a conditional probability may be represented as P(component A=failure|component B=failure), which is an expression indicating that a probability that component A fails, given the condition that component B has failed. As just referenced, such an expression may represent more complex conditional probabilities, such as P(component=failure|component B=failure, air pressure=high), in which a probability of failure of the component A is expressed as a function of an occurrence of two conditions.

Thus, in the example of FIG. 7, a network structure of components to be analyzed, and related conditions and other factors, may be constructed (702). An example of such a network structure is provided below, with respect to FIG. 8. In general, however, it may be appreciate that such a network structure is generally represented by the simplified operational workflow of the components 104-110 of FIG. 1. That is, such a network structure generally represents any operational dependencies between components, and may include any relationship between a given component and one or more other components and/or external condition, such as weather events.

In general, by itself, such a network structure may be available as part of a design of a production facility in question, and may be supplemented or otherwise leveraged by a domain expert utilizing system 100 of FIG. 1 to construct the specific type of network structure illustrated and described below with respect to FIG. 8. In any case, it will be appreciated that such a network structure may be created, as needed, by such a domain expert, perhaps in conjunction with any features or functions of the causality analyzer 130 that may be designed to assist the domain expert in this regard.

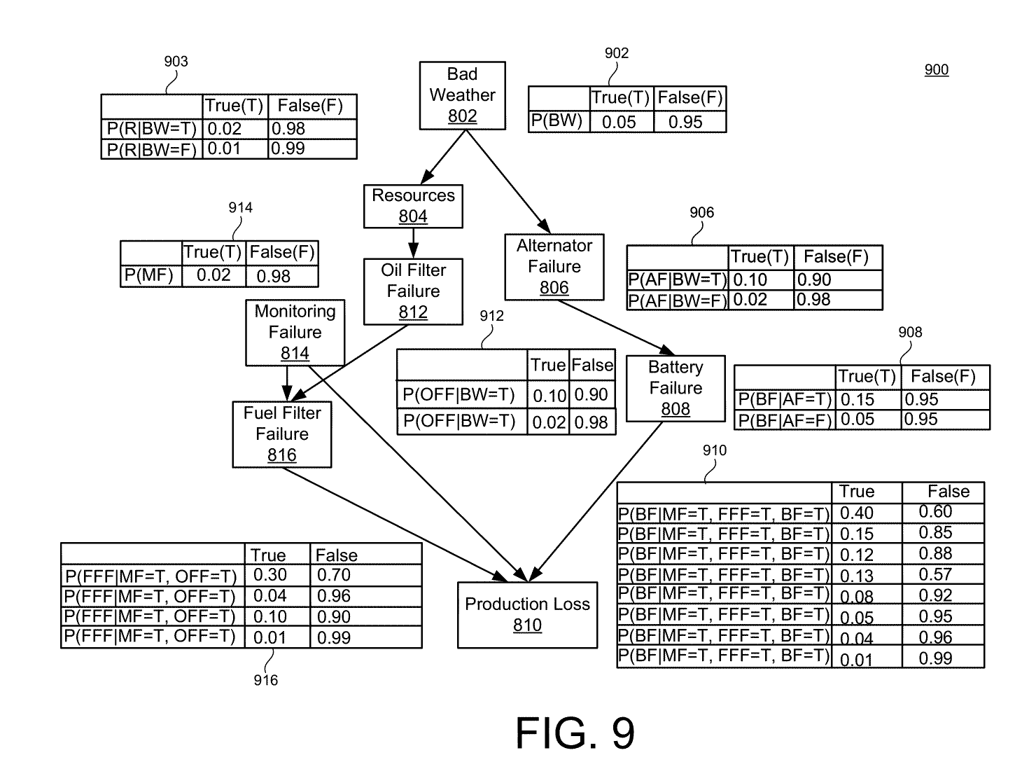

Once the network structure has been determined, probability tables may be calculated from available maintenance data (704), as illustrated and described below with respect to FIG. 9. For example, with respect to FIG. 1, it may be determined that a conditional probability failure of the component 108, when considering an actual failure of the component 106 may be only 10%, while a conditional probability of failure of the component 110 in the event of a failure of the component 106 may be much higher, e.g., 90%. Again, it may be appreciated that such conditional probabilities may be determined through analysis of available maintenance data, as described above, perhaps in conjunction with modification made by the user of the system 100.

Thus, it may be appreciated that operations 702, 704 may be conducted by the causality analyzer 130, and may be dependent upon receipt of output of the maintenance data from the maintenance data collector 112, along with critical component scores received from the critical component identifier 120. For example, in determining the network structure in operation 702, the causality analyzer 130 may utilize only critical components identified by the critical component identifier 120. In other example implementations, the network structure may include all available and included components, but may perform analysis with respect to identified critical components (e.g., may calculate probability tables and associated potential maintenance policies only with respect to such critical components).

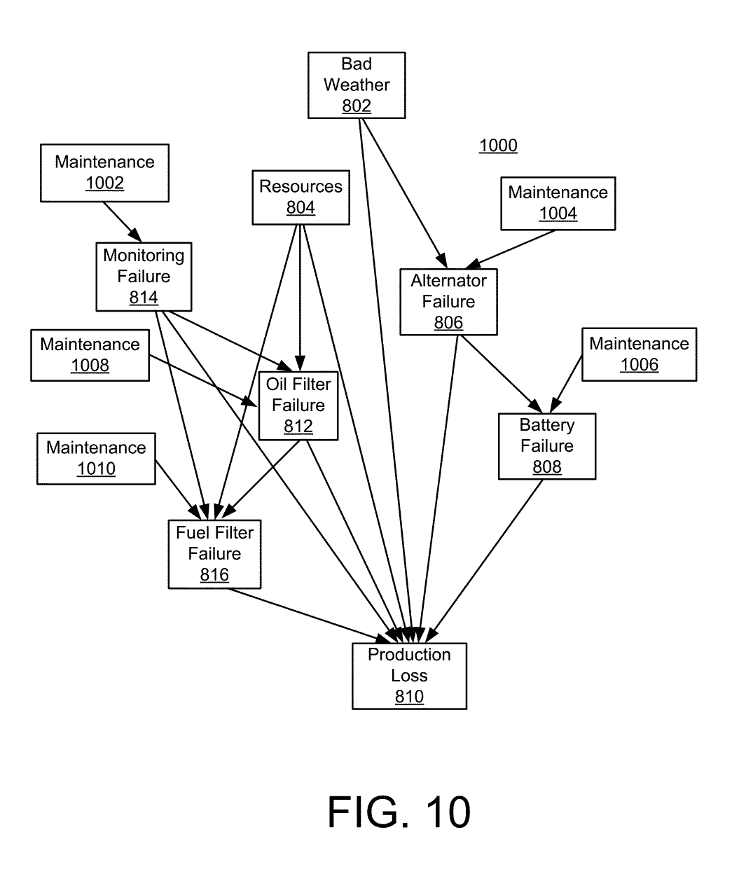

Then, operations 706-712 may be implemented by the maintenance policy generator 134. For example, as shown and described with respect to FIGS. 9 and 10, a potential maintenance policy for one or more components may be set (706). A production loss probability may be calculated for the provided maintenance policy (708). That is, a cumulative potential production loss may be calculated for a first potential maintenance policy. In this regard, it should be appreciated that the term production loss should be understood to characterize and include any direct or indirect expression of losses associated with executing the maintenance policy in question within the production facility housing the components 104-110. For example, such production losses may be characterized in terms of a loss of profitability, an opportunity cost of revenue not obtained, and/or other, less tangible characterizations of production loss with respect to, e.g., loss of reputation or customer satisfaction.

In the example of FIG. 7, if the calculated probability of production loss is not acceptable (710), then a new or modified maintenance policy may be set for a same or different component (706), and may again be evaluated on the basis of a total production loss probability (708). This process may continue until an acceptable production loss is achieved (710). At such time, a resulting maintenance policy, or plurality of potential maintenance policies, may be provided (712).

As already described, and as may be observed from the examples of FIGS. 7, operations 706-712 thus represent an iterative process for exploring a total solution space of possible maintenance policies. Such a solution space may be very large, particularly for production facilities having large numbers of components. In addition to potentially large numbers of components, potential maintenance policies may be relatively open-ended with respect to factors such as scheduling option. For example, in some cases maintenance scheduling may be essentially completely open-ended, in that the user of the system 100 is authorized to schedule maintenance as frequently as possible, given output of the system 100. In other example scenarios, scheduling constraints may exist, such as an intermittent availability of a supplier or repair personnel. In such cases, such maintenance constraints may be utilized to effectively reduce the otherwise available solution space of maintenance policies.

As also referenced, the iterative operations 706-712 may be executed in an automated fashion, so as to explore the solution space of possible maintenance policies in an efficient and thorough manner. For example, a genetic algorithm, a greedy algorithm, or other known technique exploring large solution spaces may be utilized.

FIG. 8 is a graph 800 of a network structure constructed in accordance with operation 702 of FIG. 7. That is, the graph 800 illustrates a Bayesian network structure constructed with respect to potential production losses in a gas production line. In FIG. 8, the non-limiting example of a gas production line is selection to provide an example of an industry with intense demand for operational continuity. For example, downtime of a large oil and gas plant may result in over $1M of production losses per hour. Moreover, such an oil production line provides an example in which safety and environmental concerns are relevant.

In the example of FIG. 8, an external condition of bad weather is modeled using node 802, while node 804 refers to available resources associated with the production facility that may be relevant to maintenance policies, such as a maximum maintenance frequency that may be required, given available resources. Meanwhile, nodes 806, 808, 812, 814, and 816 refer to different types of components. Specifically, as shown, a node 806 refers to an alternator component, node 808 refers to a battery, node 812 refers to an oil filter, node 814 refers to monitoring components, and node 816 refers to a fuel filter.

Specifically, in FIG. 8, the network structure 800 anticipates a potential failure of any of the components represented by nodes 806, 808, 812, 814 or 816. As a result of one or more such failures, a node 810 represents the potential for production losses that may be associated therewith.

FIG. 9 is a graph 900 representing a probability table for the network structure 800 of FIG. 8. With initial reference back to the simplified example of the components 106-110 of FIG. 1, it may be assumed for the sake of the example that the node 106 represents a parent node, while the nodes 108, 110 each represent a child node thereof. It is further assumed that each node will assume only two values, where a value of true indicates failure has occurred, and a value of false indicates a failure has not occurred.

Then, through analysis of available maintenance data, a number of times that the child node has a value of true (i.e., experiences a failure) when the parent node also has a value of true (i.e., also experiences a failure) may be counted. In a simplified example, the count of times when a child node has a value of true when the parent node has a value of true may be 3 within a given time period, while a count of a number of times that the child node equals false (i.e., does not fail) when the parent node has a value of true (i.e., experiences a failure) may equal 7. Then, the conditional probability that the child node has a value of true or false, given a value of the parent node as true, may be calculated as P(child=true|parent=true)=3/(7+3)=0.3, and P(child=false|parent=true)=7/(7+3)=0.7.

Thus, in the preceding example, it may be observed that a failure of the parent, more often than not, does not result in a failure of the child. In another example, if P(child=false|parent=false)=0.9, then it may be observed that a high correlation exists between parent and child components, because a continuing operation of the parent component is highly correlated with continuing operation of the child component. On the other hand, if P(child=false|parent=false)=0.01, then it may be observed that a failure of the parent node has a very small effect on a failure of the child node, so that the parent failure is not considered causal with respect to the child failure.

Thus, in the example of FIG. 9, a probability table 902 illustrates that a probability of bad weather has a value of 5% for true, and 95% for false, where bad weather may be defined in a manner that is most relevant to the production facility in question, and as determined from maintenance data previously collected. Meanwhile, a table 903 illustrates conditional probabilities for a resource shortage or other issue in the event of bad weather, in which the probability of resource shortage when bad weather=true is 0.02, while a probability of a resource shortage not occurring in the presence of bad weather is 0.98. Meanwhile, a probability of a resource shortage when bad weather has a value of false is 0.01, while the probability of a resource shortage not occurring when bad weather has not occurred is 0.99.

Similarly, a table 906 illustrates conditional probabilities for an alternator failure associated with the node 806, depending on whether bad weather has a value of true or false. As shown, the probability of an alternator failure when bad weather=true is 0.1, while a probability of alternator failure not occurring in the presence of bad weather is 0.9. Meanwhile, a probability of alternator failure when bad weather has a value of false is 0.02, while the probability of alternator failure not occurring when bad weather has not occurred is 0.98. In table 912, the probability of an oil filter failure when bad weather=true is 0.1, while a probability of oil filter failure not occurring in the presence of bad weather is 0.9. Meanwhile, a probability of oil filter failure when bad weather has a value of false is 0.02, while the probability of oil filter failure not occurring when bad weather has not occurred is 0.98.

In a table 914, a probability of a monitoring failure is 0.02, while a probability of a monitoring failure not occurring is 0.98. Thus, in general, and as may be appreciated from the above discussion, a probability table of a child node of one or more parent nodes may be represented as being conditional upon one or more of the preceding parent nodes. For example, as shown in a table 916, a probability of a fuel filter failure represented by the node 816 may be represented as having a 0.3 chance of being true when the failure of the oil filter, represented by the node 812, is true, and has a value of 0.7 when the failure of the oil filter is false. The probability of fuel filter failure when the monitoring failure is true and the oil filter failure is false is 0.04, while the probability of the fuel filter failure not occurring when the monitoring failure is true and the oil filter failure is false is 0.96. As may be observed from FIG. 9, additional conditional probabilities are illustrated with respect to the probability of fuel filter failure in the table 916. Similarly, accumulated condition probabilities for a battery failure 808 are illustrated with respect to the table 908.

Then, probabilities of production loss, associated with the node 810, may be represented by the table 910. As illustrated therein, and as just described, conditional probabilities for such production loss may be calculated as accumulated probabilities of each branch of parent nodes. That is, for example, in table 910, the first row can be understood as follows: given that MF=T, FFF=T and BF=T, the probability of production loss (PL)=True is 0.4 and the probability of PL=False is 0.6. In other words, if all of the monitoring filter, fuel filter and battery have experienced failure, the probability of production loss is 40%. Similar comments apply to table 916.

Of course, FIG. 9 is intended merely as a simplified example, and the illustrated values should be understood to merely illustrative, as well. As shown, for nodes with a single input, preceding values may be included or incorporated (e.g., table 908 depends on table 906, which implicitly depends on table 902). Nodes with multiple inputs account for all such inputs explicitly (e.g., table 916 depends on each of tables 912, 914, and table 910 depends on tables 916, 914, and 908).

Moreover, various techniques may be used to calculate the aggregated conditional probabilities, where some such techniques will depend on external factors and on historical data, as described herein. Further, in practice, a binary representation for production loss may be insufficient. For example, continuous intervals may be used to replace true and false in the probability tables. For example, the probability of production loss in an amount between 0-100 liters may be 0.1, the probability of production loss in an amount between 100-1000 liters may be 0.2, and so on for all relevant intervals. Nonetheless, in such scenarios, associated calculations could be performed as described herein with respect to the binary example of FIG. 9.

FIG. 10 is a graph 1000 illustrating predicted effects of maintenance policies on production losses 810. That is, as shown, maintenance activity represented by a node 1002 may be performed with respect to the monitoring failure 814. Maintenance activity represented by the node 1004 may be performed with respect to the alternator component referenced in the node 806, and maintenance activity represented by the node 1006 may be executed with respect to the battery component associated with the node 808. Similarly, maintenance node 1008, 1010 represent maintenance activities that may be enacted with respect to the oil filter component of the node 812 and the fuel filter component of the node 816, respectively.

In practice, conditional probabilities reflecting an effect of the various maintenance activities 1002-1010 may be obtained from the historical maintenance data, and/or may be predicted based on a classifier train using the Bayesian network algorithm, or other appropriate data mining algorithm. Moreover, as described, parameters for the various maintenance nodes 1002-1010 may be varied, either manually or automatically, so as to attempt to minimize the value of production loss represented by the node 810.

In this way, an impact of each component may be quantitatively characterized with respect to a final result in terms of production loss, and, similarly, a quantitative impact of one or more maintenance activities may also be assessed. For example, from statistical information obtained through an analysis of historical maintenance data, a conclusion such as “maintenance of component A three times this month will result in a component failure with probability of XX %” may be obtained. Then, a corresponding Bayesian networks structure with a maintenance input of maintenance node 1002-1010 may be trained in accordance with the example of FIG. 10, and a corresponding workflow, such as that illustrated above with respect to FIG. 5, may be implemented in order to construct a “what if” or other hypothetical test to assess the final value of the production loss represented by the node 810.

Thus, the features and functions of the systems and methods described above with respect to FIGS. 1-10 have been described with respect to techniques for supporting generation maintenance policies. It will be appreciated that many other related techniques for supporting the generation of such maintenance policies may be implemented in additional or alternative implementations. Moreover, the techniques described above may be utilized to solve a wide range of predictive maintenance problems. For example, a time of likely failure of the component may be predicted, or a time when maintenance should be required to avoid failure may be predicted.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
at least one processor; and
instructions recorded on a non-transitory computer-readable medium, and executable by the at least one processor, the system including
a maintenance data collector configured to collect maintenance data characterizing maintenance events associated with maintaining operations of a plurality of components;
a critical component identifier configured to identify, from the plurality of components and based on the maintenance data, critical components that contribute disproportionately to production losses caused by the maintenance events;
a causality analyzer configured to determine causal connections between the maintenance events, based on operational dependencies between pairs of the plurality of components; and
a maintenance policy generator configured to generate a maintenance policy governing future maintenance events for the plurality of components, based on the identified critical components and the causal connections.

2. The system of claim 1, wherein the maintenance data includes event data characterizing individual maintenance events.

3. The system of claim 1, wherein the maintenance data includes condition data collected using at least one condition sensor located in a vicinity of at least one of the plurality of components and configured to collect a time series of local conditions related to the at least one of the plurality of components at a time of at least one of the maintenance events.

4. The system of claim 1, wherein the critical component identifier comprises a score calculator configured to calculate a criticality score for each of the plurality of components, based on a comparison of each criticality score to a threshold, wherein each criticality score is calculated as an aggregation of factors related to the production losses.

5. The system of claim 4, wherein the factors include a quantity of downtime experienced by a component or type of component within a time period, relative to a quantity of downtime experienced by all of the plurality of components within the time period.

6. The system of claim 4, wherein the factors include a safety metric related to a component or type of component within a time period, relative to the safety metric experienced by all of the plurality of components within the time period.

7. The system of claim 4, wherein the factors include a quantity of environment impact factors experienced by a component or type of component within a time period, relative to a quantity of environment impact factors experienced by all of the plurality of components within the time period.

8. The system of claim 1, wherein the causality analyzer is configured to implement a machine learning algorithm to mine the maintenance data and train the maintenance policy generator to predict potential production losses associated with the future maintenance events, and thereby facilitate generation of the maintenance policy.

9. The system of claim 8, wherein the machine learning algorithm includes a Bayesian algorithm, and wherein the causality analyzer is configured to generate probability tables for corresponding nodes of a Bayesian network structure in which the nodes represent corresponding failure events of the plurality of components and reflect the operational dependencies between pairs of the plurality of components.

10. The system of claim 1, wherein the maintenance policy generator is configured to generate the maintenance policy including receiving hypothetical future maintenance events and predicting associated production losses, to thereby enable selection of the future maintenance events.

11. A computer-implemented method for executing instructions stored on a non-transitory computer readable storage medium, the method comprising:
collecting maintenance data characterizing maintenance events associated with maintaining operations of a plurality of components;
generating a criticality score for each of the plurality of components, based on a comparison of each criticality score to a threshold, wherein each criticality score is calculated as an aggregation of factors related to production losses caused by the maintenance events;
identifying, from the criticality scores, critical components that contribute to the production losses;
determining causal connections between the maintenance events, based on operational dependencies between pairs of the plurality of components; and
generating a maintenance policy governing future maintenance events for the plurality of components, based on the identified critical components and the causal connections.

12. The method of claim 11, wherein the maintenance data includes event data characterizing individual maintenance events, and wherein the maintenance data includes condition data collected using at least one condition sensor located in a vicinity of at least one of the plurality of components and configured to collect a time series of local conditions related to the at least one of the plurality of components at a time of at least one of the maintenance events.

13. The method of claim 11, wherein the factors include:
a quantity of downtime experienced by a component or type of component within a time period, relative to a quantity of downtime experienced by all of the plurality of components within the time period,
a safety metric related to a component or type of component within a time period, relative to the safety metric experienced by all of the plurality of components within the time period, and
a quantity of environment impact factors experienced by a component or type of component within a time period, relative to a quantity of environment impact factors experienced by all of the plurality of components within the time period.

14. The method of claim 11, wherein the determining causal connections includes implementing a machine learning algorithm to mine the maintenance data and train the maintenance policy generator to predict potential production losses associated with the future maintenance events, and thereby facilitate generation of the maintenance policy, and
wherein generating the maintenance policy includes receiving hypothetical future maintenance events and predicting associated production losses, to thereby enable selection of the future maintenance events.

15. A computer program product, the computer program product being tangibly embodied on a non-transitory computer-readable storage medium and comprising instructions that, when executed, are configured to cause at least one processor to:
collect maintenance data characterizing maintenance events associated with maintaining operations of a plurality of components;
identify, from the plurality of components and based on the maintenance data, critical components that contribute disproportionately to production losses caused by the maintenance events;
determine causal connections between the maintenance events, based on operational dependencies between pairs of the plurality of components; and
generate a maintenance policy governing future maintenance events for the plurality of components, based on the identified critical components and the causal connections.

16. The computer program product of claim 15, wherein the instructions, when executed, are configured to cause the at least one processor to:
calculate a criticality score for each of the plurality of components, based on a comparison of each criticality score to a threshold, wherein each criticality score is calculated as an aggregation of factors related to the production losses.

17. The computer program product of claim 15, wherein the maintenance data includes event data characterizing individual maintenance events, and wherein the maintenance data includes condition data collected using at least one condition sensor located in a vicinity of at least one of the plurality of components and configured to collect a time series of local conditions related to the at least one of the plurality of components at a time of at least one of the maintenance events.

18. The computer program product of claim 15, wherein the instructions, when executed, are configured to cause the at least one processor to:
implement a machine learning algorithm to mine the maintenance data and train the maintenance policy generator to predict potential production losses associated with the future maintenance events, and thereby facilitate generation of the maintenance policy.

19. The computer program product of claim 18, wherein the machine learning algorithm includes a Bayesian algorithm, and wherein the instructions, when executed, are configured to cause the at least one processor to:
generate probability tables for corresponding nodes of a Bayesian network structure in which the nodes represent corresponding failure events of the plurality of components and reflect the operational dependencies between pairs of the plurality of components.

20. The computer program product of claim 15, wherein the instructions, when executed, are configured to cause the at least one processor to:
generate the maintenance policy including receiving hypothetical future maintenance events and predicting associated production losses, to thereby enable selection of the future maintenance events.
